(19) United States
(12) Patent Application Publication
(10) Pub. No.: US 2014/0324414 A1
(43) Pub. Date: Oct. 30, 2014

(54) METHOD AND APPARATUS FOR DISPLAYING EMOTICON

(71) Applicant: TENCENT TECHNOLOGY (SHENZHEN) COMPANY LIMITED, Shenzhen (CN)

(72) Inventors: Xiaolong Zhang, Shenzhen (CN); Qianya Lin, Shenzhen (CN); Min Li, Shenzhen (CN); Yingxia Lin, Shenzhen (CN); Weicang Zhang, Shenzhen (CN); Linping Tang, Shenzhen (CN)

(21) Appl. No.: 14/126,439

(22) PCT Filed: May 29, 2013
(86) PCT No.: PCT/CN2013/076397

§ 371 Date: Dec. 15, 2013

(30) Foreign Application Priority Data
Apr. 28, 2013 (CN) 201310156500.X

(51) Int. Cl. G06F 17/27

(52) U.S. Cl. CPC G06F 17/277; G06F 17/276
USPC 704/9

(57) ABSTRACT

Various embodiments provide methods and apparatus for displaying an emoticon. In an exemplary method, an instant message can be received and a pre-set keyword contained in the instant message can be determined. An emoticon corresponding to the pre-set keyword contained in the instant message can then be obtained and displayed on a chat interface displaying the instant message. Accordingly, an exemplary apparatus for displaying an emoticon can include a first obtaining module, a second obtaining module, and/or a displaying module.

### CROSS-REFERENCES TO RELATED APPLICATIONS

This application claims priority to Chinese Patent Application No. CN201310156500X, filed on Apr. 28, 2013, the entire contents of which are incorporated herein by reference.

### FIELD OF THE DISCLOSURE

The present disclosure relates to the field of communication and, more particularly, relates to methods and apparatus for displaying an emoticon.

### BACKGROUND

With continuous development of communication technologies, it is more and more popular that users use instant communication tools installed in a terminal to chat with friends. The users may edit instant messages using the instant communication tools and send instant messages to friends via the instant communication tools. The users may also receive the instant messages from friends via the instant communication tools.

Currently, instant messages edited by the users via the instant communication tools are mainly text messages. The text messages as a form of instant messages may then be sent to friends via the instant communication tools. The instant messages, however, are not able to visually express what the user wants to express. It is also desirable for the instant messages to provide some chatting amusements when in use.

### BRIEF SUMMARY OF THE DISCLOSURE

According to various embodiments, there is provided a method for displaying an emoticon. In this method, an instant message can be received and a pre-set keyword contained in the instant message can be obtained. An emoticon corresponding to the pre-set keyword contained in the instant message can be obtained and displayed on a chat interface displaying the instant message.

According to various embodiments, there is also provided an apparatus for displaying an emoticon. The apparatus can include a first obtaining module, a second obtaining module, and a displaying module. The first obtaining module can be configured to receive an instant message and obtain a pre-set keyword contained in the instant message. The second obtaining module can be configured to obtain an emoticon corresponding to the pre-set keyword contained in the instant message. The displaying module can be configured to display the emoticon on a chat interface displaying the instant message.

In one embodiment, an instant message inputted by a user can be received. A pre-set keyword in the instant message can be determined and obtained. An emoticon corresponding to the pre-set keyword contained in the instant message can be obtained and displayed on a chat interface displaying the instant message. As such, displaying the emoticon on the chat interface that displays the instant message can visually express what the user wants to express and can increase chatting amusements between the user and friends of the user.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts an exemplary method for displaying an emoticon in accordance with various embodiments of the present teachings;

FIG. 2 depicts another exemplary method for displaying an emoticon in accordance with various embodiments of the present teachings;

FIG. 3 depicts another exemplary method for displaying an emoticon in accordance with various embodiments of the present teachings;

FIG. 4 depicts an exemplary chat interface displaying an emoticon in accordance with various embodiments of the present teachings;

FIG. 5 depicts another exemplary method for displaying an emoticon in accordance with various embodiments of the present teachings;

FIG. 6 depicts another exemplary chat interface displaying an emoticon in accordance with various embodiments of the present teachings;

FIG. 7 depicts an exemplary apparatus for displaying an emoticon in accordance with various embodiments of the present teachings;

FIG. 8 depicts an exemplary environment incorporating certain disclosed embodiments; and

FIG. 9 depicts an exemplary computing system in accordance with various disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

Methods and apparatus for displaying an emoticon are provided herein. In an exemplary method, an instant message can be received and a pre-set keyword contained in the instant message can be determined and obtained. An emoticon corresponding to the pre-set keyword contained in the instant message can then be obtained and displayed on a chat interface displaying the instant message. Accordingly, an exemplary apparatus for displaying an emoticon can include a first obtaining module, a second obtaining module, and/or a displaying module.

FIG. 1 depicts an exemplary method for displaying an emoticon in accordance with various embodiments of the present teachings. In Step 101, an instant message is received and a pre-set keyword contained in the instant message is obtained. In Step 102, according to the obtained pre-set keyword, an emoticon corresponding to the obtained pre-set keyword is obtained. In Step 103, the obtained emoticon is displayed on a chat interface displaying the instant message.

For example, a terminal can receive an instant message inputted by a user to obtain a pre-set keyword contained in the instant message. According to the pre-set keyword contained in the instant message, the terminal can obtain an emoticon corresponding to the pre-set keyword contained in the instant message. The terminal can display the obtained emoticon on a chat interface displaying the instant message. As such, according to the instant message, emoticon can be displayed on the chat interface displaying the instant message. By displaying emoticons (e.g., instead of text messages), it may be able to visually express what the user wants to express and to increase chatting amusements between the user and friends of the user.

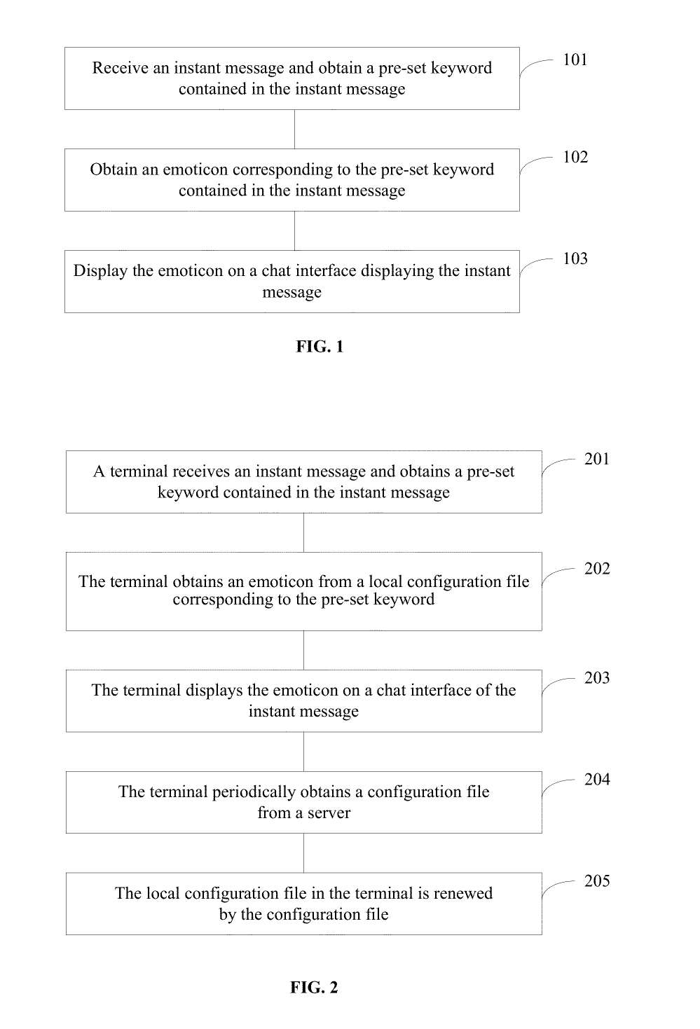

FIG. 2 depicts another exemplary method for displaying an emoticon in accordance with various embodiments of the present teachings. In Step 201, a terminal receives an instant message and obtains a pre-set keyword contained in the instant message. In various embodiments, the instant message can contain more than one pre-set keywords and the terminal can obtain these pre-set keyword(s) according to various disclosed embodiments.

As used herein, the term “a pre-set keyword” may include one word, two or more words, a set of multiple words, two or more sets of multiple words, and/or one or more sentences. For example, a pre-set keyword may be “Happy Birthday” or “Missed You” or “May You be Happy and Prosperous”, etc.

After an instant message is received, a pre-set keyword contained in the instant message can be determined and obtained. In an exemplary method for determining a pre-set keyword contained in an instant message, the terminal can determine if the instant message contains a text message after receiving the instant message. When the instant message is determined that contains a text message, the terminal can obtain a collection of pre-set keywords from a local configuration file. Based on a pre-set keyword contained in the collection of pre-set keywords, the terminal can search the instant message for the pre-set keyword. When the pre-set keyword contained in the collection of pre-set keywords is found in the instant message, the found pre-set keyword can be determined as that pre-set keyword contained in the instant message.

In another exemplary method for determining a pre-set keyword contained in an instant message, the terminal can determine if the instant message contains a text message after receiving the instant message. When the instant message is determined that contains a text message, the terminal can segment the instant message to obtain segmented words contained in the instant message. The terminal can also obtain a collection of pre-set keywords from a local configuration file. Each segmented word contained in the instant message can be compared with each pre-set keyword contained in the collection of pre-set keywords. After this comparison, a segmented word from the instant message that is the same as in a pre-set keyword contained in the collection of pre-set keywords can be determined as the pre-set keyword contained in the instant message.

In some cases, when the instant message is a voice message, the voice message can first be converted to a text message. A pre-set keyword contained in the instant message can then be determined from the converted text message according to the above-described exemplary methods for determining the pre-set keyword contained in the instant message.

In various embodiments, the collection of pre-set keywords can be obtained from a server. For example, when a pre-set keyword contained in the instant message cannot be obtained from a local configuration file according to the instant message, the pre-set keyword can be obtained from the server. In this manner, the hit rate of determining the pre-set keyword contained in the instant message can be improved.

In various embodiments, the instant message can be a message inputted by a user and received by a terminal. Alternatively, the instant message can be a message sent to the terminal from a user's friend via a server. When the terminal receives the instant message, the terminal can display an emoticon according to the methods disclosed herein.

For example, the collection of pre-set keywords may contain pre-set keywords of “Happy Birthday”, “Missed You”, “May You be Happy and Prosperous”, etc. In an embodiment when an instant message inputted by a user is “Happy Birthday to You”, the terminal can receive this instant message of “Happy Birthday to You”. The terminal can then search the instant message according to the pre-set keywords (e.g., “Happy Birthday”, “Missed You”, “May You be Happy and Prosperous”, etc.) in the collection of pre-set keywords. For example, the terminal can search the instant message according to the pre-set keyword “Happy Birthday” from the collection of pre-set keywords and may find the pre-set keyword “Happy Birthday” is contained in the instant message. The terminal can also search the instant message according to the pre-set keywords “Missed You” and “May You be Happy and Prosperous” from the collection of pre-set keywords and, in this case, may not find these pre-set keywords. The pre-set keyword “Happy Birthday” can then be determined as the pre-set keyword contained in the instant message.

In another example, the terminal can segment the received instant message “Happy Birthday to You” and the segmented words of the instant message may include “Happy Birthday”, “to”, and “You”. Each segmented word can be compared with each pre-set keyword of “Happy Birthday”, “Missed You”, and “May You be Happy and Prosperous” in the collection of pre-set keywords.

After comparison, the terminal can obtain one or more segmented words (e.g., including “Happy Birthday”, “to”, and “You”) in the instant message that are the same as in the pre-set keywords (e.g., including “Happy Birthday”, “Missed You”, and “May You be Happy and Prosperous”) from the collection of pre-set keywords. In this example, the same segmented words can be “Happy Birthday”, which can then be determined as the pre-set keyword contained in the instant message.

In Step 202, according to the pre-set keyword determined in Step 201, the terminal obtains an emoticon from a local configuration file corresponding to the determined pre-set keyword. The local configuration file can include a corresponding relationship between pre-set keywords and emoticons.

For example, according to the determined pre-set keyword and from the corresponding relationship between pre-set keywords and emoticons from the local configuration file, the terminal can search a record of an emoticon corresponding to the determined pre-set keyword, and obtain the emoticon corresponding to the determined pre-set keyword from the record.

In an embodiment when the instant message contains one pre-set keyword, the terminal can obtain an emoticon corresponding to the one pre-set keyword from the local configuration file according to the one pre-set keyword. In another embodiment when the instant message contains multiple pre-set keywords, the terminal can obtain an emoticon corresponding to each or any pre-set keyword in the multiple pre-set keywords from the local configuration file, according to the multiple pre-set keywords.

Obtaining the emoticon corresponding to the pre-set keyword from the local configuration file can reduce operation time of the terminal. Efficiency for displaying the emoticons can be improved.

Optionally, according to the determined pre-set keyword, the terminal can obtain an emoticon corresponding to the pre-set keyword from a server. For example, the terminal can send an obtaining request to the server for obtaining the emoticon. The obtaining request can contain the pre-set keyword. After receiving the pre-set keyword from the obtaining request, the server can obtain the emoticon corresponding to the pre-set keyword based on the corresponding relationship between the pre-set keywords and the emoticons. The terminal can then receive the emoticon sent by the server. As such, based on the pre-set keyword, the terminal can obtain the latest emoticon from the server.

In Step 203, the terminal displays the emoticon on a chat interface of the instant message.

In an embodiment when the instant message contains one pre-set keyword, the terminal can display the emoticon corresponding to the pre-set keyword on the chat interface of the instant message. In another embodiment when the instant message contains multiple pre-set keywords, the terminal can display an emoticon corresponding to each pre-set keyword of the multiple pre-set keywords on the chat interface of the instant message. In an additional embodiment when the instant message contains multiple pre-set keywords, an emoticon corresponding to any pre-set keyword in the multiple pre-set keywords can be displayed on the chat interface of the instant message. Displaying the emoticon on the chat interface of the instant message provides amusements for displaying the instant message and provides the user with pleasant surprises.

Further, the terminal can periodically renew the local configuration file. For example, in Step 204, the terminal periodically obtains a configuration file from the server. The configuration file contains a corresponding relationship between the pre-set keywords and the emoticons.

For example, the terminal can periodically send a renewing request to the server. The renewing request can contain a terminal identification of the terminal. The server can receive the renewing request and obtain a configuration file that is saved on the server. According to the terminal identification, the server can send the obtained configuration file to the terminal. The configuration file can include the corresponding relationship between the pre-set keywords and the emoticons.

In Step 205, the local configuration file in the terminal is renewed with the configuration file obtained from the server in Step 204.

When a user starts a client programming of an instant communication business, the terminal can renew the local configuration file. For example, the terminal can receive commands of the client programming of the instant communication business from the user and can send a renewing request to the server. In response to the renewing request, the server can send the saved configuration file to the terminal. The terminal can renew the local configuration file with the configuration file received from the server.

In this manner, when the user starts the client programming of the instant communication business, the terminal can renew the local configuration file with the latest configuration file, and then obtain the latest pre-set keywords and emoticons.

In an embodiment when the terminal receives the instant message while the terminal is renewing the local configuration file, the terminal may first complete the renewing process of the local configuration file, and then obtain an emoticon corresponding to the pre-set keyword contained in the instant message.

As disclosed, the terminal can receive the instant message inputted by the user and obtain the pre-set keyword in the instant message. According to the pre-set keyword contained in the instant message, the terminal can obtain the emoticon corresponding to the pre-set keyword and display the emoticon on the chat interface displaying the instant message. As such, displaying the emoticon on the chat interface displaying the instant message can visually express what the user wants to express and thus increase chatting amusements between the user and friends of the user.

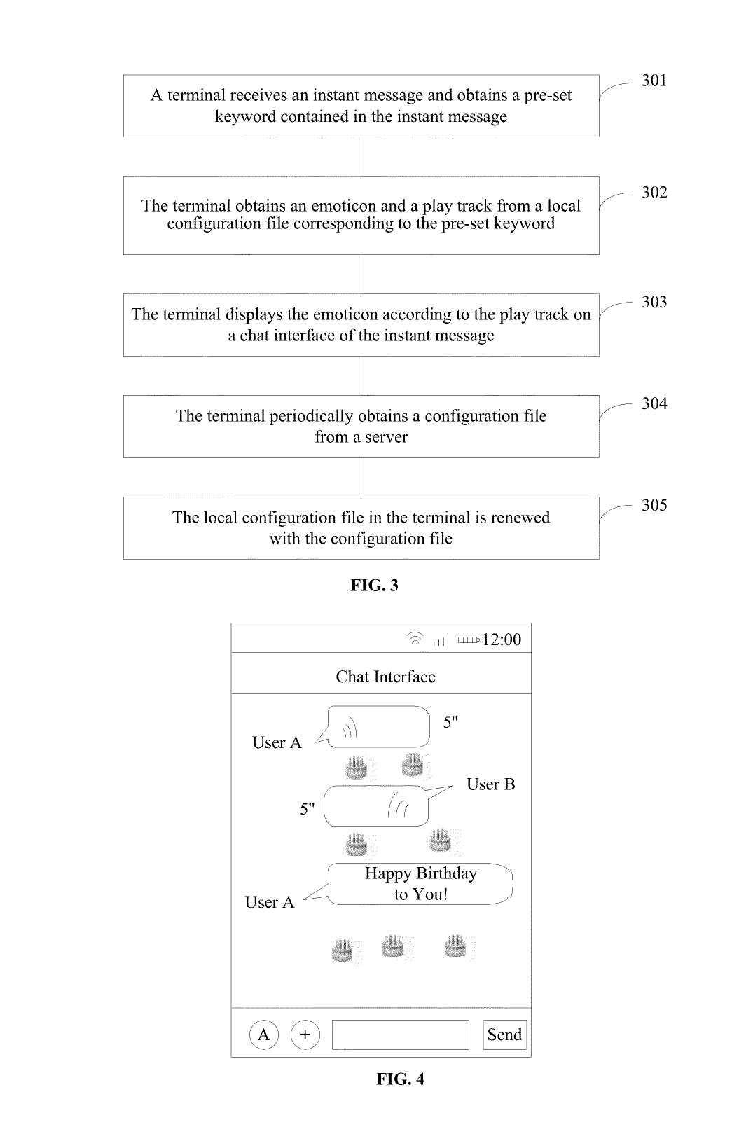

FIG. 3 depicts another exemplary method for displaying an emoticon in accordance with various embodiments of the present teachings. In Step 301, a terminal receives an instant message and obtains a pre-set keyword contained in the instant message. In various embodiments, the instant message can contain more than one pre-set keywords and the terminal can obtain these pre-set keyword(s) according to various disclosed embodiments.

In an exemplary method for determining a pre-set keyword contained in an instant message, the terminal can determine if the instant message contains a text message after receiving the instant message. When the instant message is determined that contains a text message, the terminal can obtain a collection of pre-set keywords from a local configuration file. Based on a pre-set keyword contained in the collection of pre-set keywords, the terminal can search the instant message for the pre-set keyword. When the pre-set keyword contained in the collection of pre-set keywords is found in the instant message, the found pre-set keyword can be determined as that pre-set keyword contained in the instant message.

In another exemplary method for determining a pre-set keyword contained in an instant message, the terminal can determine if the instant message contains a text message after receiving the instant message. When the instant message is determined that contains a text message, the terminal can segment the instant message to obtain segmented words contained in the instant message. The terminal can also obtain a collection of pre-set keywords from a local configuration file. Each segmented word contained in the instant message can be compared with each pre-set keyword contained in the collection of pre-set keywords. After the comparison, a segmented word from the instant message that is the same as in a pre-set keyword contained in the collection of pre-set keywords can be determined as the pre-set keyword contained in the instant message.

In some cases, when the instant message is a voice message, the voice message can first be converted to a text message. A pre-set keyword contained in the instant message can then be determined from the converted text message according to the above-described exemplary methods for determining the pre-set keyword contained in the instant message.

In various embodiments, the collection of pre-set keywords can be obtained from a server. For example, when a pre-set keyword contained in the instant message cannot be obtained from a local configuration file according to the instant message, the pre-set keyword can be obtained from the server. In this manner, the hit rate of determining the pre-set keyword contained in the instant message can be improved.

In various embodiments, the instant message can be a message inputted by a user and received by a terminal. Alternatively, the instant message can be a message sent to the terminal from a user's friend via a server. When the terminal receives the instant message, the terminal can display an emoticon according to the methods disclosed herein.

For example, the collection of pre-set keywords may contain pre-set keywords of “Happy Birthday”, “Missed You”, “May You be Happy and Prosperous”, etc. In an embodiment when an instant message inputted by a user is “Happy Birthday to You”, the terminal can receive this instant message of “Happy Birthday to You”. The terminal can then search the instant message according to the pre-set keywords (e.g., “Happy Birthday”, “Missed You”, “May You be Happy and Prosperous”, etc.) in the collection of pre-set keywords. For example, the terminal can search the instant message according to the pre-set keyword “Happy Birthday” from the collection of pre-set keywords and may find the pre-set keyword “Happy Birthday” is contained in the instant message. The terminal can also search the instant message according to the pre-set keywords “Missed You” and “May You be Happy and Prosperous” from the collection of pre-set keywords and, in this case, may not find these pre-set keywords. The found pre-set keyword “Happy Birthday” can then be determined as the pre-set keyword contained in the instant message.

In another example, the terminal can segment the received instant message “Happy Birthday to You” and the segmented words of the instant message may include “Happy Birthday”, “to”, and “You”. Each segmented word can be compared with each pre-set keyword of “Happy Birthday”, “Missed You”, and “May You be Happy and Prosperous” in the collection of pre-set keywords.

After the comparison, the terminal can obtain one or more segmented words (e.g., including “Happy Birthday”, “to”, and “You”) in the instant message that are the same as in the pre-set keywords (e.g., including “Happy Birthday”, “Missed You”, and “May You be Happy and Prosperous”) from the collection of pre-set keywords. In this example, the same segmented words can be “Happy Birthday”, which can then be determined as the pre-set keyword contained in the instant message.

In Step 302, according to the pre-set keyword determined in Step 301, the terminal obtains an emoticon and a play track from a local configuration file corresponding to the determined pre-set keyword. The local configuration file can include a corresponding relationship among pre-set keywords, emoticons, and play tracks.

For example, according to the determined pre-set keyword and from the corresponding relationship among pre-set keywords, emoticons, and play tracks from the local configuration file, the terminal can search and find the emoticon and the play track corresponding to the determined pre-set keyword.

In an embodiment when the instant message contains one pre-set keyword, the terminal can obtain an emoticon corresponding to the one pre-set keyword from the local configuration file according to the one pre-set keyword. In another embodiment when the instant message contains multiple pre-set keywords, the terminal can obtain an emoticon corresponding to each or any pre-set keyword in the multiple pre-set keywords from the local configuration file, according to the multiple pre-set keywords.

Obtaining the emoticon corresponding to the pre-set keyword from the local configuration file can reduce operation time of the terminal. Efficiency for displaying the emoticons can be improved.

Optionally, according to the determined pre-set keyword, the terminal can obtain an emoticon corresponding to the pre-set keyword from a server. For example, the terminal can send an obtaining request to the server for obtaining the emoticon. The obtaining request can contain the pre-set keyword. After receiving the pre-set keyword from the obtaining request, the server can obtain the emoticon corresponding to the pre-set keyword based on the corresponding relationship between the pre-set keywords and the emoticons. The terminal can then receive the emoticon sent by the server. As such, based on the pre-set keyword, the terminal can obtain the latest emoticon from the server.

Further, the local configuration file may also include an effective time and may further include a corresponding relationship among pre-set keywords, emoticons, play tracks, and/or effective times. According to this corresponding relationship, the terminal can obtain an emoticon, a play track, and/or an effective time according to the determined pre-set keyword.

The play track can include a play path of the emoticon and/or a displaying time of the emoticon. For example, the play path can roll the emoticon from top to bottom or from right to left. The displaying time can be a time for displaying the emoticon, e.g., for about 2 seconds or other time length as desired.

Table 1 lists an exemplary corresponding relationship among pre-set keywords, emoticons, and play tracks. According to Table 1, the terminal can, for example, find an emoticon (e.g., Emoticon 1) and obtain a play track (e.g., Play Track 1) corresponding to a pre-set keyword (e.g., “Happy Birthday”).

TABLE 1

| Pre-Set Keyword | Emoticon | Play Track |
|---|---|---|
| Happy Birthday | Emoticon 1 | Play Track 1 |
| Missed you | Emoticon 2 | Play Track 2 |
| May You be Happy | Emoticon 3 | Play Track 3 |
| and Prosperous | | |

In Step 303, the terminal displays the emoticon according to the obtained play track on a chat interface of the instant message.

In an embodiment when the instant message contains one pre-set keyword, the terminal can display the emoticon corresponding to the pre-set keyword on the chat interface of the instant message. In another embodiment when the instant message contains multiple pre-set keywords, the terminal can display an emoticon corresponding to each pre-set keyword of the multiple pre-set keywords on the chat interface of the instant message. In an additional embodiment when the instant message contains multiple pre-set keywords, an emoticon corresponding to any pre-set keyword in the multiple pre-set keywords can be displayed on the chat interface of the instant message.

Displaying the emoticon according to the obtained play track on the chat interface of the instant message can dynamically display the emoticon to increase the dynamic sense and provide the user with pleasant surprises.

In an embodiment that the local configuration file includes a corresponding relationship among pre-set keywords, emoticons, play tracks and/or effective times, before the terminal obtains the emoticon according to the obtained play track, the terminal can obtain a current time and compare the current time with the effective time corresponding to the pre-set keyword. When the current time is within such effective time, the emoticon can be displayed according to the obtained play track on the chat interface of the instant message.

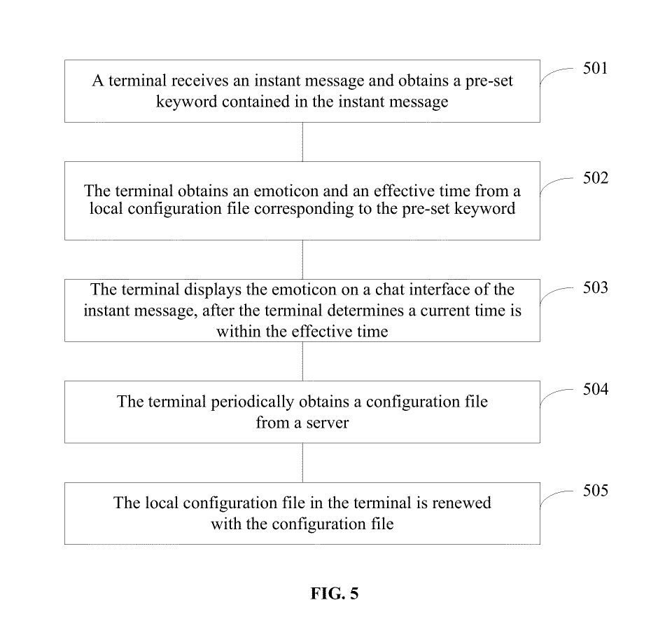

For example, corresponding to the pre-set keyword “Happy Birthday” in Table 1, Play Track 1 may be the play track to display the emoticon by rolling from top to bottom and the emoticon may be a picture of cake. As shown on an exemplary chat interface in FIG. 4, when user A inputs an instant message of “Happy Birthday to You”, an emoticon containing a picture of cake and corresponding to the pre-set keyword can be displayed on the exemplary chat interface in a snake-like form.

Further the terminal can periodically renew the local configuration file. For example, in Step 304, the terminal periodically obtains a configuration file from the server. The configuration file contains a corresponding relationship between the pre-set keywords, the emoticons, and the play tracks.

For example, the terminal can periodically send a renewing request to the server. The renewing request can contain a terminal identification of the terminal. The server can receive the renewing request and obtain a configuration file that is saved on the server. According to the terminal identification, the server can send the obtained configuration file to the terminal. The configuration file can include the corresponding relationship between the pre-set keywords, the emoticons, and the play tracks.

In Step 305, the local configuration file in the terminal is renewed with the configuration file obtained in Step 304.

When a user starts a client programming of an instant communication business, the terminal can renew the local configuration file. For example, the terminal can receive commands of the client programming of the instant communication business from the user and can send a renewing request to the server. In response to the renewing request, the server can send the saved configuration file to the terminal. The terminal can renew the local configuration file with the configuration file received from the server.

In this manner, when the user starts the client programming of the instant communication business, the terminal can renew the local configuration file with the latest configuration file, and then obtain the latest pre-set keywords, emoticons, play tracks, and effective times.

In an embodiment when the terminal receives the instant message while the terminal is renewing the local configuration file, the terminal may first complete the renewing process of the local configuration file, and then obtain an emoticon corresponding to the pre-set keyword contained in the instant message, a play track of the emoticon, and an effective time of the emoticon.

As disclosed, the terminal can receive the instant message inputted by the user and obtain the pre-set keyword in the instant message. According to the pre-set keyword contained in the instant message, the terminal can obtain the emoticon and the play track corresponding to the pre-set keyword and display the emoticon according to the play track on a chat interface displaying the instant message. As such, displaying the emoticon on the chat interface displaying the instant message according to the play track can dynamically and visually express what the user wants to express and thus increase chatting amusements between the user and friends of the user.

FIG. 5 depicts another exemplary method for displaying an emoticon in accordance with various embodiments of the present teachings.

In Step 501, a terminal receives an instant message and obtains a pre-set keyword contained in the instant message. In various embodiments, the instant message can contain more than one pre-set keywords and the terminal can obtain these pre-set keyword(s) according to various disclosed embodiments.

In an exemplary method for determining a pre-set keyword contained in an instant message, the terminal can determine if the instant message contains a text message after receiving the instant message. When the instant message is determined that contains a text message, the terminal can obtain a collection of pre-set keywords from a local configuration file. Based on a pre-set keyword contained in the collection of pre-set keywords, the terminal can search the instant message for the pre-set keyword. When the pre-set keyword contained in the collection of pre-set keywords is found in the instant message, the found pre-set keyword can be determined as that pre-set keyword contained in the instant message.

In another exemplary method for determining a pre-set keyword contained in an instant message, the terminal can determine if the instant message contains a text message after receiving the instant message. When the instant message is determined that contains a text message, the terminal can segment the instant message to obtain segmented words contained in the instant message. The terminal can also obtain a collection of pre-set keywords from a local configuration file. Each segmented word contained in the instant message can be compared with each pre-set keyword contained in the collection of pre-set keywords. After this comparison, a segmented word from the instant message that is the same as in a pre-set keyword contained in the collection of pre-set keywords can be determined as the pre-set keyword contained in the instant message.

In some cases, when the instant message is a voice message, the voice message can first be converted to a text message. A pre-set keyword contained in the instant message can then be determined from the converted text message according to the above-described exemplary methods for determining the pre-set keyword contained in the instant message.

In various embodiments, the collection of pre-set keywords can be obtained from a server. For example, when a pre-set keyword contained in the instant message cannot be obtained from a local configuration file according to the instant message, the pre-set keyword can be obtained from the server. In this manner, the hit rate of determining the pre-set keyword contained in the instant message can be improved.

In various embodiments, the instant message can be a message inputted by a user and received by a terminal. Alternatively, the instant message can be a message sent to the terminal from a user's friend via a server. When the terminal receives the instant message, the terminal can display an emoticon according to the methods disclosed herein.

For example, the collection of pre-set keywords may contain pre-set keywords of “Happy Birthday”, “Missed You”, “May You be Happy and Prosperous”, “Happy New Year” etc. In an embodiment when an instant message inputted by a user is “Wish You a Happy New Year”, the terminal can receive this instant message of “Wish You a Happy New Year”. The terminal can then search the instant message according to the pre-set keywords (e.g., “Happy Birthday”, “Missed You”, “May You be Happy and Prosperous”, “Happy New Year”, etc.) in the collection of pre-set keywords. For example, the terminal can search the instant message according to the pre-set keyword “Happy New Year” from the collection of pre-set keywords and may find the pre-set keyword “Happy New Year” is contained in the instant message. The terminal can also search the instant message according to the pre-set keywords “Happy Birthday”, “Missed You”, and “May You be Happy and Prosperous” from the collection of pre-set keywords and, in this case, may not find these pre-set keywords. The pre-set keyword “Happy New Year” can then be determined as the pre-set keyword contained in the instant message.

In another example, the terminal can segment the received instant message “Wish You a Happy New Year” and the segmented words of the instant message may include “Wish”, “You”, and “Happy New Year”. Each segmented word can be compared with each pre-set keyword of “Happy Birthday”, “Missed You”, “May You be Happy and Prosperous”, and “Happy New Year” in the collection of pre-set keywords.

After comparison, the terminal can obtain one or more segmented words (e.g., including “Wish”, “You”, and “Happy New Year”) in the instant message that are the same as in the pre-set keywords (e.g., including “Happy Birthday”, “Missed You”, “May You be Happy and Prosperous”, and “Happy New Year”) from the collection of pre-set keywords. In this example, the segmented word “Happy New Year” can then be determined as the pre-set keyword contained in the instant message.

In Step 502, according to the pre-set keyword determined in Step 501, the terminal obtains an emoticon and an effective time from a local configuration file corresponding to the determined pre-set keyword. The local configuration file can include a corresponding relationship among pre-set keywords, emoticons, and/or effective times.

For example, according to the determined pre-set keyword and from the corresponding relationship among pre-set keywords, emoticons, and/or effective times from the local configuration file, the terminal can search and find the emoticon and the effective time corresponding to the determined pre-set keyword.

In an embodiment when the instant message contains one pre-set keyword, the terminal can obtain an emoticon corresponding to the one pre-set keyword from the local configuration file according to the one pre-set keyword. In another embodiment when the instant message contains multiple pre-set keywords, the terminal can obtain an emoticon corresponding to each or any pre-set keyword in the multiple pre-set keywords from the local configuration file, according to the multiple pre-set keywords.

Obtaining the emoticon and effective time corresponding to the pre-set keyword from the local configuration file can reduce operation time of the terminal. Efficiency for displaying the emoticons can be improved.

Optionally, according to the determined pre-set keyword, the terminal can obtain an emoticon corresponding to the pre-set keyword from a server. For example, the terminal can send an obtaining request to the server for obtaining the emoticon. The obtaining request can contain the pre-set keyword. After receiving the pre-set keyword from the obtaining request, the server can obtain the emoticon corresponding to the pre-set keyword based on the corresponding relationship between the pre-set keywords and the emoticons. The terminal can then receive the emoticon sent by the server. As such, based on the pre-set keyword, the terminal can obtain the latest emoticon from the server.

Further, the local configuration file may also include a play track, and a corresponding relationship among pre-set keywords, emoticons, play tracks, and/or effective times. According to the corresponding relationship, the terminal can obtain an emoticon, a play track, and an effective time according to the determined pre-set keyword.

The play track can include a play path of the emoticon, and/or a displaying time of the emoticon. For example, the play path can roll the emoticon from top to bottom or from right to left. The displaying time can be the time for displaying the emoticon, e.g., for about 2 seconds or other time length as desired.

Table 2 lists an exemplary corresponding relationship among pre-set keywords, emoticons, and effective times. Based on Table 2, the terminal can, for example, find an emoticon (e.g., Emoticon 4) corresponding to a pre-set keyword (e.g., “Happy New Year”) and obtain an effective time (e.g., 01/01-01/07).

TABLE 2

| Pre-Set Keyword | Emoticon | Effective Time |
|---|---|---|
| Happy Birthday | Emoticon 1 | 01/01-12/31 |
| Missed you | Emoticon 2 | 01/01-12/31 |
| May You be Happy and | Emoticon 3 | 01/01-02/01 |
| Prosperous | | |
| Happy New Year | Emoticon 4 | 01/01-01/07 |

In Step 503, when the terminal obtains a current time and the current time is within the effective time, the terminal displays the emoticon on a chat interface of the instant message.

For example, the terminal can obtain a current time; compare the current time with the effective time of the emoticon; and determine if the current time is within the effective time. When the current time is determined within the effective time, the terminal can display the emoticon on the chat interface of the instant message. In the case when the current time is determined not within the effective time, the terminal does not display the emoticon on the chat interface of the instant message and the operation ends.

In an embodiment when the instant message contains one pre-set keyword, the terminal can display the emoticon corresponding to the pre-set keyword on the chat interface of the instant message. In another embodiment when the instant message contains multiple pre-set keywords, the terminal can display an emoticon corresponding to each pre-set keyword of the multiple pre-set keywords on the chat interface of the instant message. In an additional embodiment when the instant message contains multiple pre-set keywords, an emoticon corresponding to any pre-set keyword in the multiple pre-set keywords can be displayed on the chat interface of the instant message.

Displaying the emoticon on the chat interface of the instant message can increase amusements for displaying emoticons and provide the user with pleasant surprises.

In an embodiment that the local configuration file includes a corresponding relationship among pre-set keywords, emoticons, play tracks and/or effective times, before the terminal obtains the emoticon according to the obtained play track, the terminal can obtain a current time and compare the current time with the effective time corresponding to the pre-set keyword. When the current time is within such effective time, the emoticon can be displayed according to the obtained play track on the chat interface of the instant message.

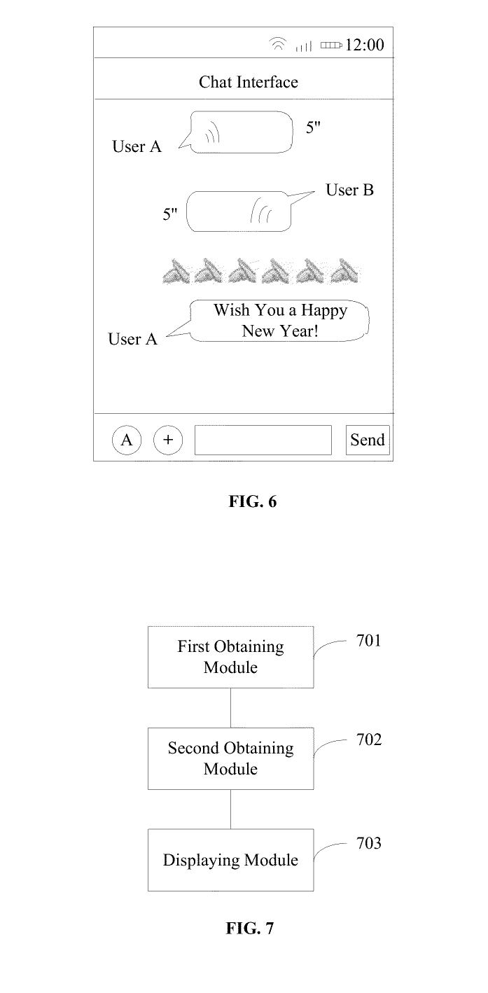

For example, when the current time is about 12:00 pm on a date of January 5, i.e., within the effective time of 01/01-01/07 corresponding to Emoticon 4 as depicted in Table 2, the terminal can display Emoticon 4. On an exemplary chat interface in FIG. 6, when user A inputs an instant message of “Wish You a Happy New Year” shown on the exemplary chat interface, an emoticon (e.g., having a form of greeting with one clenched first in the other hand) corresponding to the pre-set keyword “Happy New Year” can be shown on the exemplary chat interface.

Further, the terminal can periodically renew the local configuration file. For example, in Step 504, the terminal periodically obtains a configuration file from the server. The configuration file contains a corresponding relationship between the pre-set keywords, the emoticons, and/or the effective times.

For example, the terminal can periodically send a renewing request to the server. The renewing request can contain a terminal identification of the terminal. The server can receive the renewing request and obtain a configuration file that is saved on the server. According to the terminal identification, the server can send the obtained configuration file to the terminal. The configuration file can include the corresponding relationship between the pre-set keywords, the emoticons, and the effective times.

In Step 505, the local configuration file in the terminal is renewed with the configuration file obtained in Step 504.

When a user starts a client programming of an instant communication business, the terminal can renew the local configuration file. For example, the terminal can receive commands of the client programming of the instant communication business from the user and can send a renewing request to the server. In response to the renewing request, the server can send the saved configuration file to the terminal. The terminal can renew the local configuration file with the configuration file received from the server.

In this manner, when the user starts the client programming of the instant communication business, the terminal can renew the local configuration file with the latest configuration file, and then obtain the latest pre-set keywords, emoticons, play tracks, and/or effective times.

In an embodiment when the terminal receives the instant message while the terminal is renewing the local configuration file, the terminal may first complete the renewing process of the local configuration file, and then obtain an emoticon corresponding to the pre-set keyword contained in the instant message, a play track of the emoticon, and/or an effective time of the emoticon.

As disclosed, the terminal can receive the instant message inputted by the user and obtain the pre-set keyword in the instant message. According to the pre-set keyword contained in the instant message, the terminal can obtain the emoticon and display the emoticon according to the play track on the chat interface displaying the instant message. As such, displaying the emoticon on the chat interface for displaying the instant message according to the effective time of the pre-set keyword can provide time-based effects and pleasant surprises to the users and increase chatting amusements between the user and friends of the user.

FIG. 7 depicts an exemplary apparatus for displaying an emoticon in accordance with various embodiments of the present teachings. The exemplary apparatus can include a first obtaining module 701, a second obtaining module 702, and/or a displaying module 703.

The first obtaining module 701 can be configured to receive an instant message and obtain a pre-set keyword of the instant message. In some embodiments, to obtain the pre-set keyword of the instant message, the first obtaining module 701 can be configured to determine if the instant message contains a text message. When the instant message is determined that does not contain a text message but contains, for example, a voice message. The voice message can be converted to a text message. When the instant message is determined that contains the text message, a collection of pre-set keywords can be obtain from a local configuration file. The first obtaining module 701 can further be configured to search the text message contained in the instant message for each pre-set keyword from the collection of pre-set keywords. When a pre-set keyword in the collection of pre-set keywords is found in the instant message, the first obtaining module 701 can be configured to determine that the found pre-set keyword is the pre-set keyword contained in the instant message.

In other embodiments, to obtain the pre-set keyword of the instant message, the first obtaining module 701 can be configured to determine if the instant message contains a text message. When the instant message is determined that does not contain a text message but contains, for example, a voice message. The voice message can be converted to a text message. When the instant message is determined that contains the text message, the first obtaining module 701 can be configured to segment the instant message to obtain segmented words contained in the instant message and then obtain a collection of pre-set keywords from a local configuration file. Each segmented word contained in the instant message can be compared with each pre-set keyword in the collection of pre-set keywords. The first obtaining module 701 can be configured to determine a segmented word from the instant message that is a same as in a pre-set keyword from the collection of pre-set keywords as the pre-set keyword contained in the instant message.

Based on the obtained pre-set keyword of the instant message, the second obtaining module 702 can be configured to obtain an emoticon corresponding to the pre-set keyword. The displaying module 703 can be configured to display the emoticon obtained by the second obtaining module 702 on a chat interface displaying instant message.

The second obtaining module 702 can include a first obtaining unit. The first obtaining unit can be configured, according to the pre-set keyword, to obtain the emoticon corresponding to the pre-set keyword from a local configuration file. The local configuration file can be configured to store a corresponding relationship between the pre-set keywords and the emoticons. Further, the local configuration file can be configured to store a play track and/or an effective time of each emoticon included in the corresponding relationship between the pre-set keywords and the emoticons. Accordingly, the second obtaining module 702 can include a second obtaining unit. The second obtaining unit can be configured to obtain a play track and/or an effective time of each emoticon from the local configuration file.

The displaying module 703 can include a displaying unit. The displaying unit can be configured to display the emoticon on the chat interface of the instant message according to the play track and/or the effective time of the emoticon.

In various embodiments, the exemplary apparatus can further include a third obtaining module, and/or a renewing module. The third obtaining module can be configured to periodically obtain a configuration file from a server. The configuration file can at least include a corresponding relationship between the pre-set keywords and the emoticons. The renewing module can be configured to renew the local configuration file with the obtained configuration file.

As disclosed, the terminal can receive an instant message inputted by the user and obtain the pre-set keyword contained in the instant message. According to the pre-set keyword contained in the instant message, the terminal can obtain the emoticon corresponding to the pre-set keyword and display the emoticon on the chat interface of the instant message. As such, according to the instant message, displaying the emoticon on the chat interface of the instant message can visually express what the user wants to express and thus increase chatting amusements between the user and friends of the user.

In various embodiments, the disclosed modules/units in the exemplary apparatus as depicted above can be configured in one device or configured in multiple devices as desired. The modules disclosed herein can be integrated in one module or in multiple modules for processing messages. Each of the modules disclosed herein can be divided into one or more sub-modules, which can be recombined in any manners. The exemplary apparatus in FIG. 7 can be used to perform the above-disclosed methods, e.g., in FIGS. 1-6, for displaying emoticons on the chat interface of the instant message.

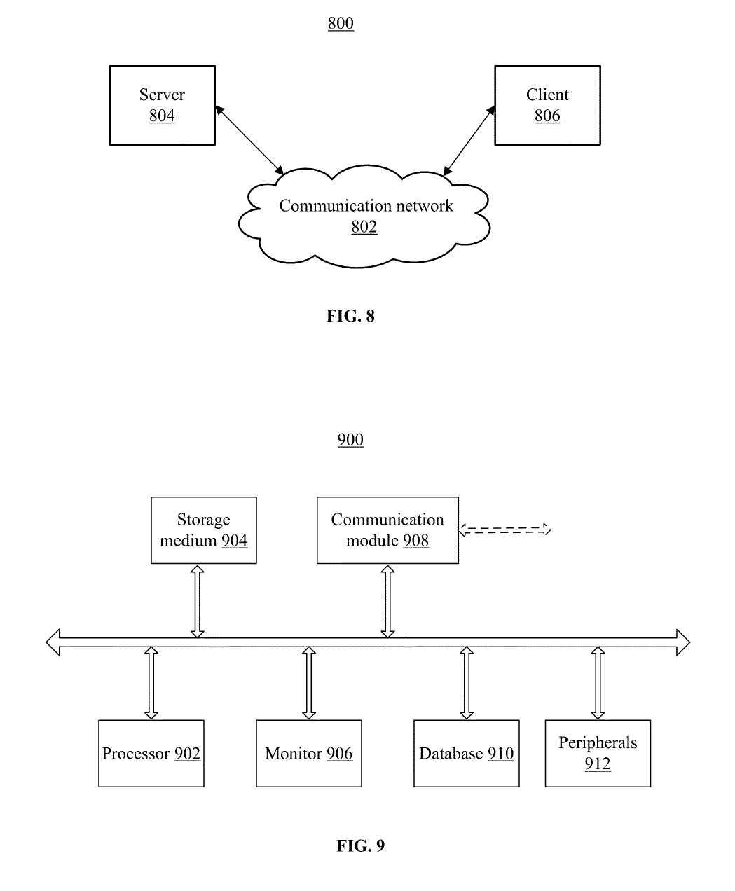

The disclosed embodiments can be examples only. One of ordinary skill in the art would appreciate that suitable software and/or hardware (e.g., a universal hardware platform) may be included and used to perform the disclosed methods. For example, the disclosed embodiments can be implemented by hardware only, which alternatively can be implemented by software products only. The software products can be stored in a storage medium (e.g., as shown in FIG. 9). The software products can include suitable commands to enable a terminal device (e.g., including a mobile phone, a personal computer, a server, or a network device, etc.) to implement the disclosed embodiments.

FIG. 8 depicts an exemplary environment 800 incorporating certain disclosed embodiments. As shown in FIG. 8, environment 800 may include a server 804, a terminal or a client 806, and/or a communication network 802. The server 804 and the client 806 may be coupled through the communication network 802 for information exchange, such as obtaining web data. Although only one client 806 and one server 804 are shown in the environment 800, any number of clients 806 or servers 804 may be included, and other devices may also be included.

Communication network 802 may include any appropriate type of communication network for providing network connections to the server 804 and client 806 or among multiple servers 804 or clients 806. For example, communication network 802 may include the Internet or other types of computer networks or telecommunication networks, either wired or wireless.

A terminal or a client, as used herein, may refer to any appropriate user terminal with certain computing capabilities, such as a personal computer (PC), a work station computer, a server computer, a hand-held computing device (tablet), a smart phone or mobile phone, or any other user-side computing device. Such terminals can be used in the disclosed methods as depicted in FIGS. 1-6.

A server, as used herein, may refer to one or more server computers configured to provide certain server functionalities, such as database management and search engines. A server may also include one or more processors to execute computer programs in parallel. In one embodiment, the server can be used in the disclosed methods as depicted in FIGS. 1-6.

Server 804 and/or client 806 may be implemented on any appropriate computing platform. FIG. 9 shows a block diagram of an exemplary computing system 900 capable of implementing server 904 and/or client 906.

As shown in FIG. 9, computing system 900 may include a processor 902, a storage medium 904, a monitor 906, a communication module 908, a database 910, and/or peripherals 912. Certain devices may be omitted and other devices may be included.

Processor 902 may include any appropriate processor or processors. Further, processor 902 can include multiple cores for multi-thread or parallel processing. Storage medium 904 may include memory modules, such as ROM, RAM, flash memory modules, and erasable and rewritable memory, and mass storages, such as CD-ROM, U-disk, and hard disk, etc. Storage medium 904 may store computer programs for implementing various processes, when executed by processor 902.

Further, peripherals 912 may include I/O devices such as keyboard and mouse, and communication module 908 may include network devices for establishing connections through the communication network 902. Database 910 may include one or more databases for storing certain data and for performing certain operations on the stored data, such as database searching.

Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Methods and apparatus for displaying an emoticon on a chat interface of an instant message are provided. In an exemplary method, an instant message can be received and a pre-set keyword contained in the instant message can be determined. An emoticon corresponding to the pre-set keyword contained in the instant message can then be obtained and displayed on the chat interface that displays the instant message.

An exemplary apparatus can include a first obtaining module, a second obtaining module, and/or a displaying module. The first obtaining module can be configured to receive an instant message and obtain a pre-set keyword contained in the instant message. The second obtaining module can be configured to obtain an emoticon corresponding to the pre-set keyword contained in the instant message. The displaying module can be configured to display the emoticon on a chat interface displaying the instant message.

In one embodiment, an instant message inputted by a user can be received. A pre-set keyword in the instant message can be determined and obtained. An emoticon corresponding to the pre-set keyword contained in the instant message can be obtained and displayed on a chat interface displaying the instant message. As such, displaying the emoticon on the chat interface that displays the instant message can visually express what the user wants to express and can increase chatting amusements between the user and friends of the user.

What is claimed is:

1. A method for displaying an emoticon, comprising:
receiving an instant message and obtaining a pre-set keyword contained in the instant message;
obtaining an emoticon corresponding to the pre-set keyword contained in the instant message; and
displaying the emoticon on a chat interface displaying the instant message.

2. The method of claim 1, wherein the obtaining of the emoticon corresponding to the pre-set keyword comprises:
according to the pre-set keyword, obtaining the emoticon corresponding to the pre-set keyword from a local configuration file, wherein the local configuration file comprises a corresponding relationship between pre-set keywords and emoticons.

3. The method of claim 2, wherein the local configuration file further comprises: a play track, an effective time, and their combinations, of each emoticon included in the corresponding relationship, and wherein, after obtaining the emoticon corresponding to the pre-set keyword from the local configuration file, the method further comprises:
obtaining, the play track, the effective time, and their combinations, of the emoticon from the local configuration file.

4. The method of claim 3, wherein the displaying of the emoticon on the chat interface comprises:
displaying the emoticon on the chat interface based on the play track, the effective time, and their combinations, of the emoticon.

5. The method of claim 1, further comprising:
periodically obtaining a configuration file from a server, the configuration file at least comprising a corresponding relationship between pre-set keywords and emoticons; and
renewing a local configuration file with the obtained configuration file.

6. The method of claim 1, wherein the pre-set keyword contained in the instant message is obtained by:
determining if the instant message contains a text message;
obtaining a collection of pre-set keywords from a local configuration file, when the instant message is determined that contains the text message;
searching the text message contained in the instant message for each pre-set keyword from the collection of pre-set keywords; and
when a pre-set keyword in the collection of pre-set keywords is found in the instant message, determining the found pre-set keyword is the pre-set keyword contained in the instant message.

7. The method of claim 1, wherein the pre-set keyword contained in the instant message is obtained by:
determining if the instant message contains a text message;
segmenting the instant message to obtain segmented words contained in the instant message, when the instant message is determined that contains the text message;
obtaining a collection of pre-set keywords from a local configuration file;
comparing each segmented word contained in the instant message with each pre-set keyword in the collection of pre-set keywords; and
determining a segmented word from the instant message that is a same as in a pre-set keyword from the collection of pre-set keywords as the pre-set keyword contained in the instant message.

8. An apparatus for displaying an emoticon, comprising:
a first obtaining module, configured to receive an instant message and to obtain a pre-set keyword contained in the instant message;
a second obtaining module, configured to obtain an emoticon corresponding to the pre-set keyword contained in the instant message; and
a displaying module, configured to display the emoticon on a chat interface displaying the instant message.

9. The apparatus of claim 8, wherein the second obtaining module comprises:
a first obtaining unit, configured to obtain the emoticon corresponding to the pre-set keyword from a local configuration file, wherein the local configuration file is configured to store a corresponding relationship between pre-set keywords and emoticons.

10. The apparatus of claim 9, wherein the local configuration file is further configured to store a play track, an effective time, and their combinations, of the emoticon included in the corresponding relationship, and wherein the second obtaining module further comprises:
a second obtaining unit, configured to obtain the play track, the effective time, and their combinations, of the emoticon from the local configuration file.

11. The apparatus of claim 10, wherein the displaying module comprises:
a displaying unit, configured to display the emoticon on the chat interface based on the play track, the effective time, and their combinations, of the emoticon.

12. The apparatus of claim 8, further comprising:
a third obtaining module, configured to periodically obtain a configuration file from a server, the configuration file at least comprising a corresponding relationship between pre-set keywords and emoticons; and
a renewing module, configured to renew a local configuration file with the obtained configuration file.

13. The apparatus of claim 8, wherein, to obtain the pre-set keyword contained in the instant message, the first obtaining module is configured to:
determine if the instant message contains a text message;
obtain a collection of pre-set keywords from a local configuration file, when the instant message is determined that contains the text message;
search the text message contained in the instant message for each pre-set keyword from the collection of pre-set keywords; and
when a pre-set keyword in the collection of pre-set keywords is found in the instant message, determine the found pre-set keyword is the pre-set keyword contained in the instant message.

14. The apparatus of claim 8, wherein, to obtain the pre-set keyword contained in the instant message, the first obtaining module is configured to:
determine if the instant message contains a text message;
segment the instant message to obtain segmented words contained in the instant message, when the instant message is determined that contains the text message;
obtain a collection of pre-set keywords from a local configuration file;
compare each segmented word contained in the instant message with each pre-set keyword in the collection of pre-set keywords; and
determine a segmented word from the instant message that is a same as in a pre-set keyword from the collection of pre-set keywords as the pre-set keyword contained in the instant message.
